(19) United States
(12) Patent Application Publication
(10) Pub. No.: US 2011/0262249 A1
(43) Pub. Date: Oct. 27, 2011

(54) One person round bale transporter

(76) Inventor: Ross Edward Canen, Glendive, MT (US)

(21) Appl. No.: 12/702,310

(22) Filed: Apr. 22, 2010

(51) Int. Cl. B62D 51/04; B62D 57/00

(52) U.S. Cl. 414/24.5

(57) ABSTRACT

The practical use of this invention allows one person to transport a round hay/forage bale a short distance without assistance from a tractor or other vehicle. The power source is a cordless drill that rolls the bale along the ground essentially turning it into a large diameter wheel. The relatively low cost and unique feature of using a cordless drill as a power source to move such a large cylindrical object is new to the hay/forage transportation industry.

### CROSS-REFERENCE TO RELATED APPLICATIONS

“Not Applicable”

### STATEMENT REGARDING FEDERALLY SPONSORED RESEARCH/DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF INVENTION

The field of endeavor that this invention addresses is agricultural hay/forage transportation problems. A problem arised when I needed to move some round hay bales to my horses about 150 feet away. There was snow on the ground and it was 25 degrees below zero and my tractor wouldn't start and the animals needed hay. My wife and I began pushing and rolling a round bale towards the horses. This was hard work and not efficient use of our time. I began thinking of a way to move a single round bale without the use of a tractor or pickup truck apparatus. I assumed that most people had a cordless drill available so I made my design around that power source.

Some prior U.S. Pat. Nos. 5,178,505 and 5,129,775 and 4,527,935 and 4,674,786 and 4,249,842 and 4,306,825 all transport round hay bales but they need either a tractor or another vehicle to accomplish this task. This invention would allow for a person to move a small quantity of round bales throughout the year. This would apply to small scale or hobby farms and ranches. A person can even “roll” a round bale up a ramp onto a flatbed trailer with this invention. Because of the large surface area of a round bale, the bale has an added benefit of riding on top of the snow while it is being rolled, in most cases. Problems occurred in the past when snow was drifted and a path had to be cleared before the tractor or pickup truck could be used to transport the hay bale to its destination.

### SUMMARY OF INVENTION

This invention was created to address problems that many people have if they do not have access to a tractor with a loader and/or a pickup truck without a hay bale mover apparatus. A cordless drill creates the torque necessary to rotate a cylindrical hay/forage bale in essence turning it into a large diameter wheel that rolls along the ground while the operator walks alongside applying force with the drill. No additional force either hydraulic, electrical or mechanical is needed. This invention is ideal for someone that has a few round bales and needs to move them over relatively short distances.

### BRIEF DESCRIPTION OF THE SEVERAL VIEWS OF THE DRAWING

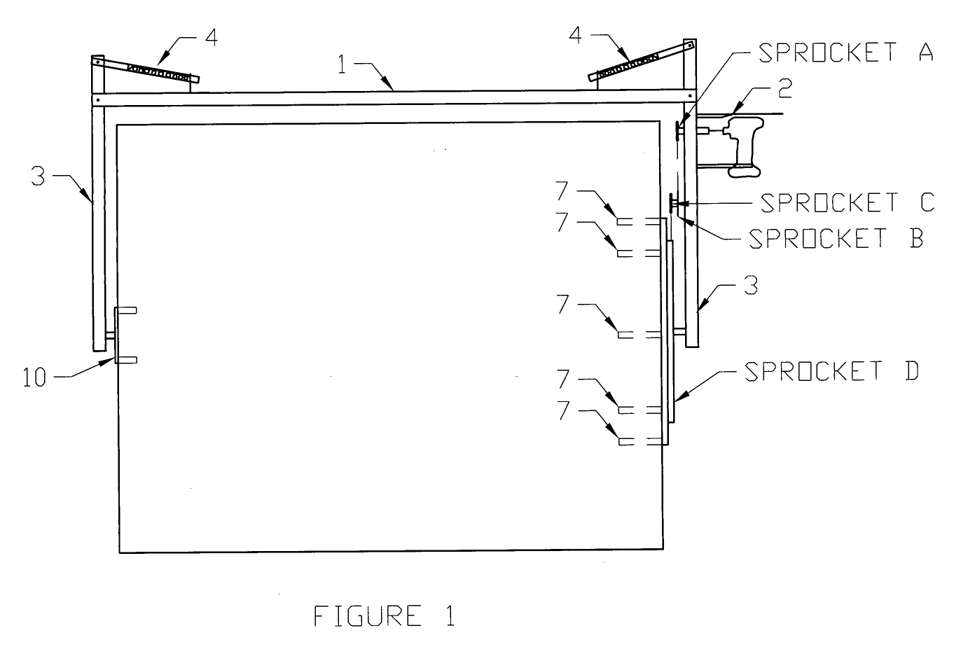

(FIG. 1) depicts the invention secured to the ends of the round bale excluding the A-frame structure for illustrative purposes. (FIG. 1) would be the front view or broadside view.

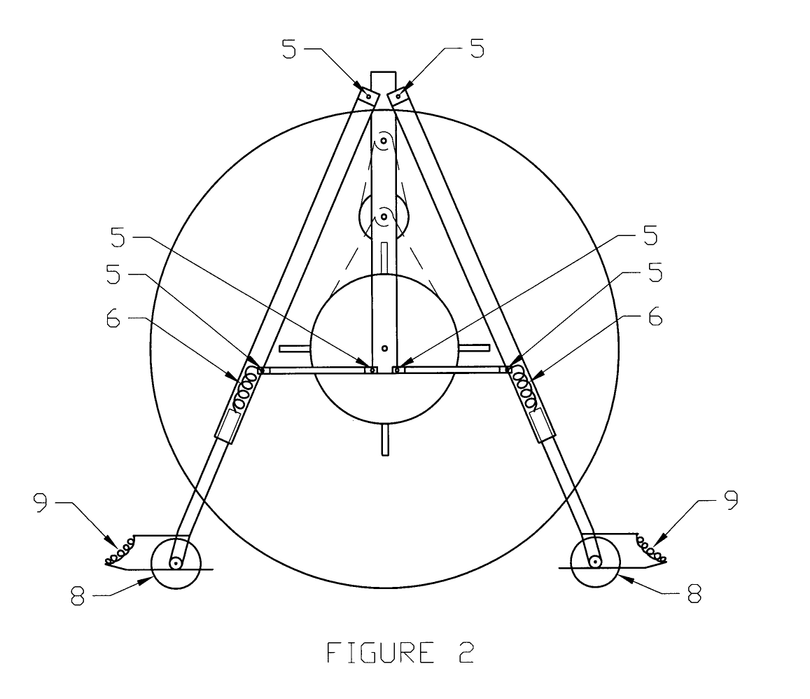

(FIG. 2) depicts the side view as the invention is secured to the round bale. This side is referenced as the “power side” since the cordless drill is attached to this side. Both (FIG. 1) and (FIG. 2) are not made to scale and are for illustrative purposes only.

### DETAILED DESCRIPTION OF INVENTION

This invention allows a person to move a round hay bale a short distance without the aid of a tractor or other vehicle. The sole power source is an 18 volt cordless drill. This metal and/or aluminum composed machine in essence turns the round bale into its own large wheel that rolls along the ground to your desired location. This invention is comprised of one horizontal rectangular tube (#1 FIG. 1) that spans the length of the bale. At each end of the horizontal tube is a vertical rectangular tube (#3 FIG. 1) that is hinged allowing for each vertical piece to move freely “in and out”. Each vertical tube has a compression spring (#4 FIG. 1) at the top with a nut on a threaded rod to allow for different squeeze pressures on the ends of the bale.

One side or end of this invention (power side) has (4) four different sized sprockets that allows a gear ratio of 90:1. This amplification of the standard 18 volt cordless drill torque creates the required final torque to rotate the bale. The standard 18 volt drill produces approximately 40 foot/pounds of torque. With the stated gear ratio there should be approximately 3800 foot/pounds of torque applied to the bale. The cordless drill is first secured into its cradle (#2 FIG. 1) that holds the drill securely. The drill is connected, via a shaft to a 2 inch diameter sprocket (sprocket A, FIG. 1) which turns a larger 12 inch diameter sprocket (sprocket B, FIG. 1) with the aid of a 40 roller chain that connects the two. In turn, this larger sprocket (sprocket B, FIG. 1) is paired with a smaller sprocket with a 2 inch diameter (sprocket C, FIG. 1) mounted on the same shaft. This sprocket (sprocket C) is connected to the largest and final sprocket (sprocket D, FIG. 1) with the aid of a 50 roller chain. The diameter of (sprocket D) is 30 inches. This final sprocket (sprocket D) has attached to (9) nine, six inch long spears (#7 FIG. 1) that go into the end of the bale to grip it. These mini-spears are mounted onto angle iron/aluminum which is bolted to (sprocket D).

The counter rotational force that is created is addressed by the A-frame structure created on the power side (FIG. 2). This structure is attached with hinge pins (#5 FIG. 2) for easy removal and storage. This structure allows for the bale to be rotated in either direction by switching the direction switch on the drill. The (2) two long diagonal legs of this structure have a compression spring (#6 FIG. 2) inside the two telescoping pieces to allow for limited uneven ground terrain. At the end of each leg is a (5) five inch pneumatic tire (#8 FIG. 2) that is mounted on a swivel castor. An optional component is small skis (#9 FIG. 2) that can be attached to the balance point of the swivel wheels axles. These skis distribute the weight over a larger area making it able to traverse most snow conditions.

The opposite end of the invention (#10 FIG. 1) or non-power side also has an identical vertical rectangular tube. There are no sprockets on this end. There is a small 12 inch diameter gripper that freely rotates on a bearing as the bale rotates. This vertical arm also has a compression spring at the top that as the threaded rod is tightened more inward or squeezing pressure is applied to the bale.

The invention is used by positioning the invention next to the front of the bale. With both compression springs somewhat loose (by loosening the nut on the threaded rod) take the non-power side vertical arm and pull it to the center of the cylindrical bale. Next, take the power side vertical arm and pull it over and center it in the end of the bale. Once both sides are centered then the nuts on the two compression springs can be tightened. The nut on the power side has to have slightly more pressure that the non-power side spring. The legs on the A-frame structure may have to be adjusted depending on the size of the bale. Once the mini-spears are embedded into the end of the bale firmly then the operator stands to the side and activates the cordless drill. The bale rotates at a slow walk for the operator. (Never stand in front or behind of a moving bale).

1. This invention does not need any additional equipment to operate (i.e. tractor hydraulics or pickup truck with a bale handling apparatus) other than a functional 18 volt cordless drill or a corded drill.

2. With this invention one person can move a large cylindrical hay/forage bale a short distance.

3. This invention incorporates the unique concept of turning a large cylindrical hay/forage bale into its own wheel for transportation.
